(19) United States
(12) Patent Application Publication
(10) Pub. No.: US 2022/0022084 A1
(43) Pub. Date: Jan. 20, 2022

(54) COMPUTING DEVICE AND METHOD USING A NEURAL NETWORK TO INFER A PREDICTED STATE OF A COMMUNICATION CHANNEL

(71) Applicant: Distech Controls Inc., Brossard (CA)

(72) Inventor: Francois Gervais, Lachine (CA)

(21) Appl. No.: 17/490,621

(22) Filed: Sep. 30, 2021

Related U.S. Application Data
(63) Continuation-in-part of application No. 16/003,430, filed on Jun. 8, 2018.

(51) Int. Cl. H04W 24/10; G06N 3/04; G06N 3/08; G06N 3/063; H04L 12/28

(52) U.S. Cl. CPC H04W 24/10; G06N 3/04; G06N 3/08; H04L 2012/285; H04L 12/2803; H04L 2012/2841; G06N 3/063

(57) ABSTRACT

Method and computing device for inferring a predicted state of a communication channel. The computing device stores a predictive model generated by a neural network training engine. The computing device collects a plurality of data samples representative of operating conditions of the communication channel. The communication channel is associated to a communication interface of the computing device. The communication interface allows an exchange of data between the computing device and at least one remote computing device over the communication channel. Each data sample comprises a measure of the amount of data respectively transmitted and received by the communication interface over the communication channel and a connection status of the communication channel, during a period of time. The computing device further executes a neural network inference engine using the predictive model for inferring the predicted state of the communication channel based on the plurality of data samples.

### CROSS-REFERENCE TO RELATED APPLICATIONS

This is a Continuation-in-Part application of U.S. patent application Ser. No. 16/003,430, filed Jun. 8, 2018, the disclosure of which is incorporated herein by reference in its entirety for all purposes.

### TECHNICAL FIELD

The present disclosure relates to the field of environment control systems. More specifically, the present disclosure relates to a computing device and method using a neural network to infer a predicted state of a communication channel.

### BACKGROUND

Systems for controlling environmental conditions, for example in buildings, are becoming increasingly sophisticated. A control system may at once control heating and cooling, monitor air quality, detect hazardous conditions such as fire, carbon monoxide release, intrusion, and the like. Such control systems generally include at least one environment controller, which receives measured environmental values, generally from external sensors, and in turn determines set-points or command parameters to be sent to controlled appliances.

Communications between an environment controller and the devices under its control (sensors, controlled appliances, etc.) were traditionally based on wires. The wires are deployed in the building where the environment control system is operating, for instance in the walls, ceilings, and floors of multiple rooms in the building. Deploying wires in a building is usually disrupting for the daily operations in the building and costly. Thus, recently deployed environment controllers and devices under their control (sensors, controlled appliances, etc.) are using one or more wireless communication protocol (e.g. Wi-Fi, mesh, etc.) to exchange environmental data.

The environment controller and the devices under its control (sensors, controlled appliances, etc.) are generally referred to as Environment Control Devices (ECDs). An ECD comprises processing capabilities for processing data received via one or more communication interface and/or generating data transmitted via the one or more communication interface. Each communication interface may be of the wired or wireless type.

A communication channel is associated to the communication interface of an ECD. The communication channel represents a physical and/or logical media allowing an exchange of data between the ECD and at least one remote computing device. For example, the communication channel consists of a cable plugged into the communication interface. Alternatively, the communication channel consists of one or more radio channels established by the communication interface.

The communication channel requires high availability and resistance to transmission errors. However, when using certain protocols such as the Internet Protocol (IP), nothing is actually occurring on the communication channel unless an actual communication over the communication channel is taking place. This makes it hard to detect if the communication channel is not in an operational state when nothing is transmitted over the communication channel for a certain amount of time. For example, if a computing device is in a listening only state on the communication interface, it is hard to tell whether the fact of receiving no data through the communication channel is normal or if the communication channel is not in an operational state.

However, current advances in artificial intelligence, and more specifically in neural networks, can be taken advantage of to define a model taking into consideration sample data representative of past operating conditions of the communication channel to predict a current state of the communication channel.

Therefore, there is a need for a new computing device and method using a neural network to infer a predicted state of a communication channel.

### SUMMARY

According to a first aspect, the present disclosure relates to a computing device. The computing device comprises a communication interface. The communication interface allows an exchange of data between the computing device and at least one remote computing device over a communication channel associated to the communication interface. The computing device comprises memory for storing a predictive model generated by a neural network training engine. The computing device comprises a processing unit for collecting a plurality of data samples representative of operating conditions of the communication channel. Each data sample comprises a measure of the amount of data transmitted by the communication interface over the communication channel during a period of time, a measure of the amount of data received by the communication interface over the communication channel during the period of time, and a connection status of the communication channel during the period of time. The processing unit further executes a neural network inference engine using the predictive model for inferring a predicted state of the communication channel based on the plurality of data samples.

According to a second aspect, the present disclosure relates to a method using a neural network to infer a predicted state of a communication channel. The method comprises storing a predictive model generated by a neural network training engine in a memory of a computing device. The method comprises collecting, by a processing unit of the computing device, a plurality of data samples representative of operating conditions of the communication channel. The communication channel is associated to a communication interface of the computing device. The communication interface allows an exchange of data between the computing device and at least one remote computing device over the communication channel. Each data sample comprises a measure of the amount of data transmitted by the communication interface over the communication channel during a period of time, a measure of the amount of data received by the communication interface over the communication channel during the period of time, and a connection status of the communication channel during the period of time. The method further comprises executing, by the processing unit of the computing device, a neural network inference engine using the predictive model for inferring the predicted state of the communication channel based on the plurality of data samples.

According to a third aspect, the present disclosure relates to a non-transitory computer program product comprising instructions executable by a processing unit of a computing device. The execution of the instructions by the processing unit of the computing device provides for using a neural network to infer a predicted state of a communication channel, by implementing the aforementioned method.

### BRIEF DESCRIPTION OF THE DRAWINGS

Embodiments of the disclosure will be described by way of example only with reference to the accompanying drawings, in which:

FIG. 1 illustrates an environment control device (ECD) using a neural network for inferring a predicted state of a communication channel;

FIG. 2 illustrates a method implemented by the ECD of FIG. 1 for using a neural network to infer a predicted state of a communication channel;

FIGS. 3A, 3B and 3C illustrate examples of communication channels associated to a communication interface of the ECD of FIG. 1;

FIGS. 4A and 4B illustrate the inference of the predicted state of the communication channel according to the method of FIG. 2;

FIG. 5 illustrates an environment control system where an environment controller implements the method of FIG. 2;

FIG. 6 represents an environment control system where ECDs implementing the method of FIG. 2 are deployed;

FIG. 7 is a schematic representation of the neural network inference engine executed by the ECD of FIG. 1;

FIG. 8 represents an alternative environment control system where ECDs are under the control of a centralized inference server; and

FIGS. 9, 10 and 11 represent exemplary implementations of a neural network implemented by the neural network inference engine of FIG. 7.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to predicting a state of a communication channel associated to a communication interface of a computing device. More specifically, the present disclosure addresses computing devices consisting of environment control devices (ECDs), which exchange environmental data with other components of an environment control system via a communication channel associated to a communication interface of the ECDs.

### Terminology

The following terminology is used throughout the present disclosure:
Environment: condition(s) (temperature, pressure, oxygen level, light level, security, etc.) prevailing in a controlled area or place, such as for example in a building.
Environment control system: a set of components which collaborate for monitoring and controlling an environment.
Environmental data: any data (e.g. information, commands) related to an environment that may be exchanged between components of an environment control system.
Environment control device (ECD): generic name for a component of an environment control system. An ECD may consist of an environment controller, a sensor, a controlled appliance, etc.
Environment controller: device capable of receiving information related to an environment and sending commands based on such information.
Environmental characteristic: measurable, quantifiable or verifiable property of an environment.
Environmental characteristic value: numerical, qualitative or verifiable representation of an environmental characteristic.
Sensor: device that detects an environmental characteristic and provides a numerical, quantitative or verifiable representation thereof. The numerical, quantitative or verifiable representation may be sent to an environment controller.
Controlled appliance: device that receives a command and executes the command. The command may be received from an environment controller.
Relay: device capable of relaying an environmental characteristic value from a sensor to an environment controller and/or relaying a command from an environment controller to a controlled appliance.
Environmental state: a current condition of an environment based on an environmental characteristic, each environmental state may comprise a range of values or verifiable representation for the corresponding environmental characteristic.

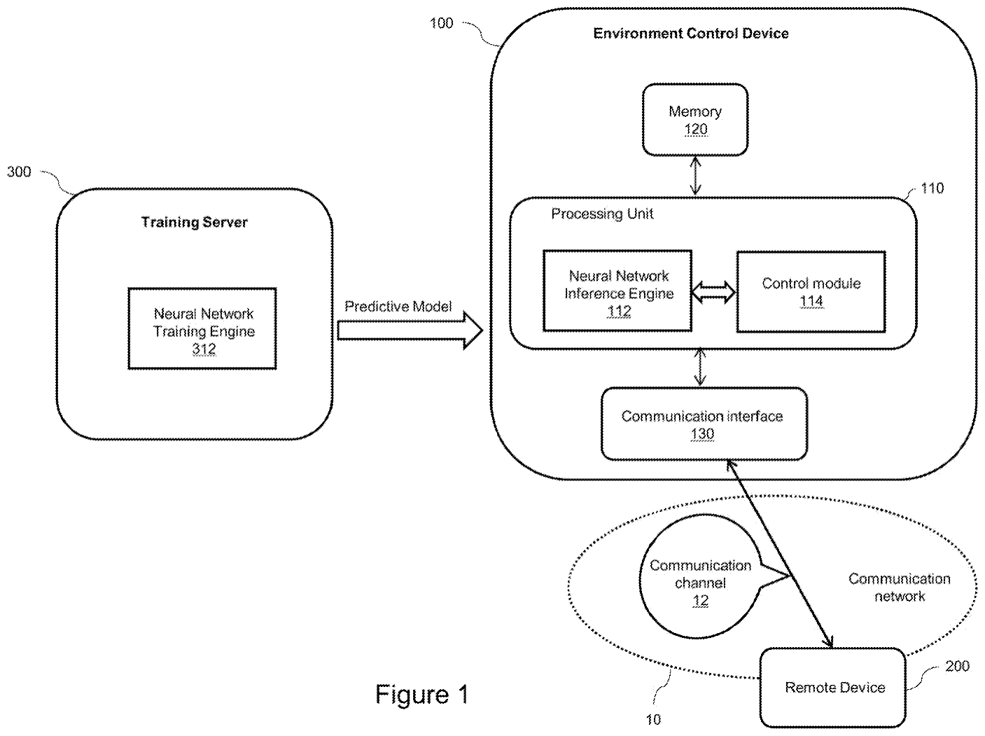

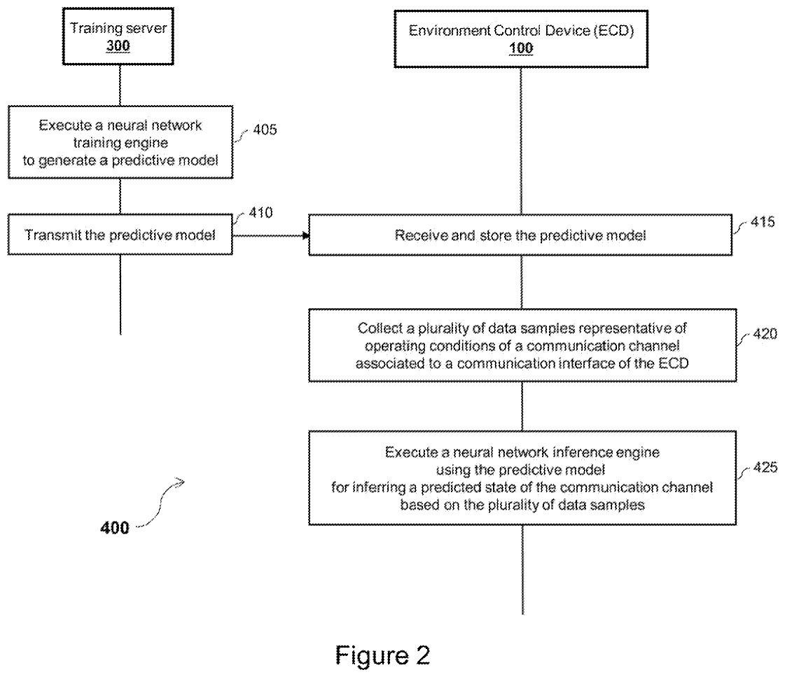

Referring now concurrently to FIGS. 1, 2, 3A, 3B, 3C, 4A and 4B, an environment control device (ECD) 100 (represented in FIG. 1) and a method 400 (represented in FIG. 2) using a neural network to infer a predicted state of a communication channel are illustrated.

The ECD 100 comprises a processing unit 110, memory 120, and a communication interface 130. The ECD 100 may comprise additional components (not represented in FIG. 1 for simplification purposes), such as another communication interface, a user interface, a display, etc.

The processing unit 110 comprises one or more processors (not represented in FIG. 1) capable of executing instructions of a computer program. Each processor may further comprise one or several cores.

The memory 120 stores instructions of computer program(s) executed by the processing unit 110, data generated by the execution of the computer program(s), data received via the communication interface 130 (or another communication interface), etc. Only a single memory 120 is represented in FIG. 1, but the ECD 100 may comprise several types of memories, including volatile memory (such as a volatile Random Access Memory (RAM), etc.) and non-volatile memory (such as a hard drive, electrically-erasable programmable read-only memory (EEPROM), etc.).

The communication interface 130 allows the ECD 100 to exchange data with one or more remote device(s) 200 over a communication network 10. For example, the communication network 10 is a wired communication network, such as an Ethernet network; and the communication interface 130 is adapted to support communication protocols used to exchange data over the Ethernet network 10. Other types of wired communication networks 10 may also be supported by the communication interface 130. In another example, the communication network 10 is a wireless communication network, such as a Wi-Fi network; and the communication interface 130 is adapted to support communication protocols used to exchange data over the Wi-Fi network 10. Other types of wireless communication network 10 may also be supported by the communication interface 130, such as a wireless mesh network.

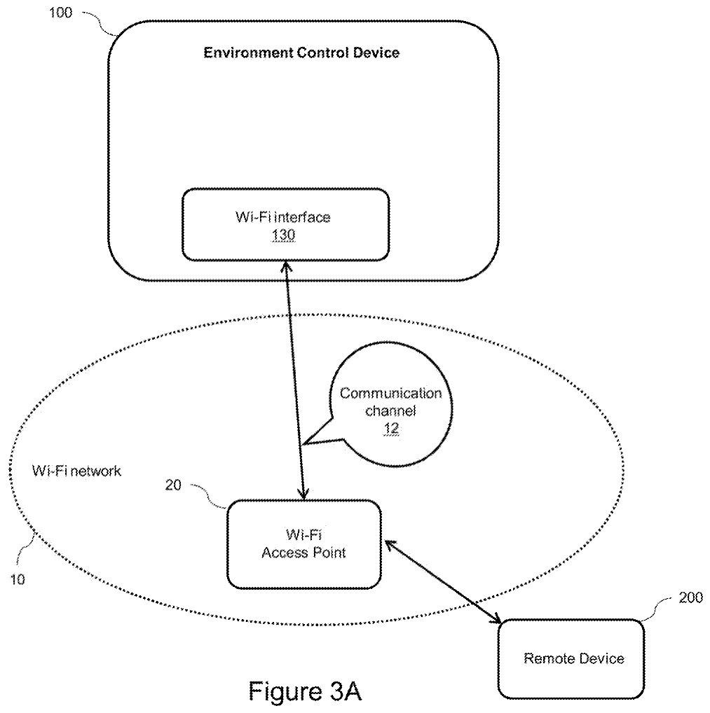

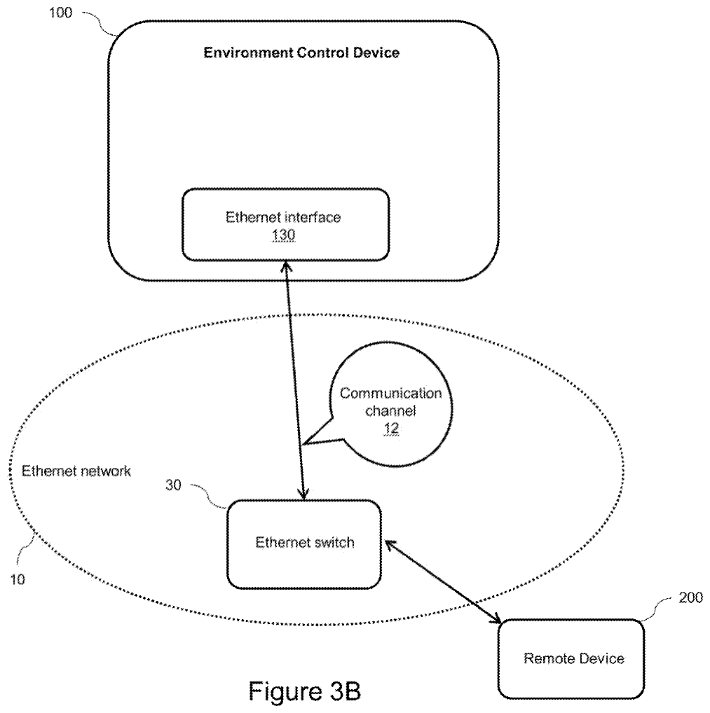

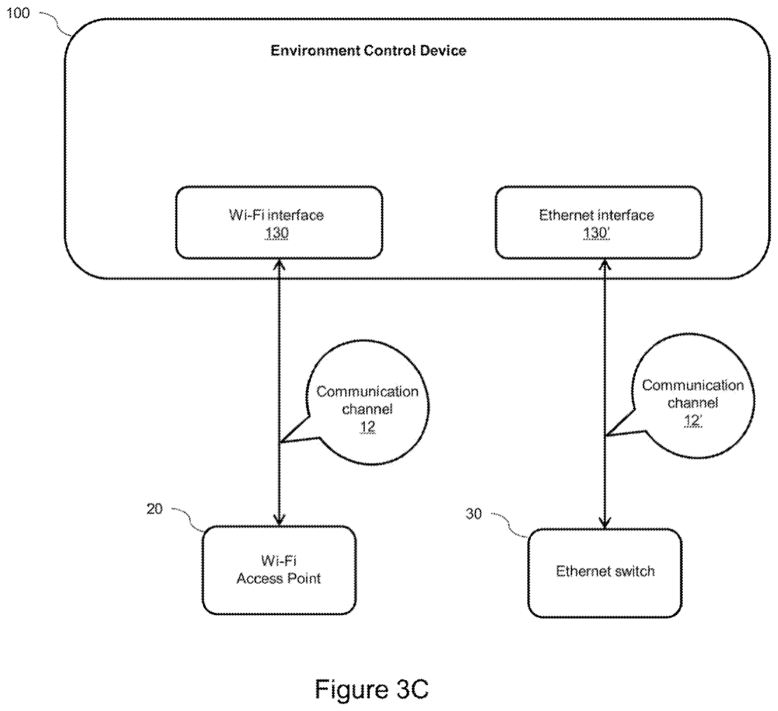

Referring more specifically to FIGS. 1, 3A, 3B and 3C, a communication channel 12 associated to the communication interface 130 of the ECD 100 is represented. The communication channel 12 represents a physical and/or logical media allowing an exchange of data between the ECD 100 and the remote device 200 through the communication network 10. The communication interface 130 transmits data to the remote device 200 over the communication channel 12 and receives data from the remote device 200 over the communication channel 12. Generally, the communication channel 12 does not extend all the way between the communication interface 130 and the remote device 200, but between the communication interface 130 and an intermediate networking equipment, as illustrated in FIGS. 3A and 3B.

FIG. 3A represents a communication channel 12 associated to a Wi-Fi interface 130, allowing an exchange of data between the ECD 100 and the remote device 200 via a Wi-Fi network 10. The communication channel 12 is between the Wi-Fi interface 130 of the ECD 100 and a Wi-Fi access point 20. The communication channel 12 consists of one or more radio channel compliant with at least one of the IEEE 802.11 standards. The communication channel 12 associated to the Wi-Fi interface 130 is set up by associating the Wi-Fi interface 130 with the Wi-Fi access point 20, as is well known in the 802.11 standards.

FIG. 3B represents a communication channel 12 associated to an Ethernet interface 130, allowing an exchange of data between the ECD 100 and the remote device 200 via an Ethernet network 10. The communication channel 12 is between the Ethernet interface 130 of the ECD 100 and an Ethernet switch (or router) 30. The communication channel 12 consists of an Ethernet cable connecting an Ethernet port of the Ethernet interface 130 to an Ethernet port of the Ethernet switch (or router) 30. The communication channel 12 associated to the Ethernet interface 130 is set up by plugging the Ethernet cable into the Ethernet port of the Ethernet interface 130.

FIG. 3C represents an ECD 100 comprising a Wi-Fi interface 130 and an Ethernet interface 130′. A first communication channel 12 similar to the one represented in FIG. 3A is associated to the Wi-Fi interface 130. A second communication channel 12′ similar to the one represented in FIG. 3B is associated to the Ethernet interface 130′.

The communication channels 12 and 12′ represented in FIGS. 3A, 3B and 3C are for illustration purposes only. A person skilled in the art would readily understand that other types of communication channels can be associated to a wired or wireless communication interface 130 of the ECD 100.

Reference is now made more specifically to FIG. 2. At least some of the steps of the method 400 are implemented by the ECD 100, to use a neural network for inferring a predicted state of the communication channel 12.

A dedicated computer program has instructions for implementing at least some of the steps of the method 400. The instructions are comprised in a non-transitory computer program product (e.g. the memory 120) of the ECD 100. The instructions provide for using a neural network to infer a predicted state of the communication channel 12, when executed by the processing unit 110 of the ECD 100. The instructions are deliverable to the ECD 100 via an electronically-readable media such as a storage media (e.g. CD-ROM, USB key, etc.), or via communication links (e.g. via the communication network 10 through the communication interface 130).

The dedicated computer program product executed by the processing unit 110 comprises a neural network inference engine 112 and a control module 114.

Also represented in FIG. 1 is a training server 300. Although not represented in FIG. 1 for simplification purposes, the training server comprises a processing unit, memory and a communication interface. The processing unit of the training server 300 executes a neural network training engine 312.

The execution of the neural network training engine 312 generates a predictive model, which is transmitted to the ECD 100 via the communication interface of the training server 300. For example, the predictive model is transmitted over the communication network 10 and received via the communication interface 130 of the ECD 100. Alternatively, the predictive model is transmitted over another communication network not represented in FIG. 1; and received via another communication interface of the ECD 100 not represented in FIG. 1.

The method 400 comprises the step 405 of executing the neural network training engine 312 to generate the predictive model. Step 405 is performed by the processing unit of the training server 300.

The method 400 comprises the step 410 of transmitting the predictive model to the ECD 100, via the communication interface of the training server 300. Step 410 is performed by the processing unit of the training server 300.

The method 400 comprises the step 415 of receiving the predictive model by the ECD 100, via the communication interface 130 of the ECD 100. Step 415 further comprises storing the predictive model in the memory 120 of the ECD 100. Step 415 is performed by the processing unit 110 of the ECD 100.

The method 400 comprises the step 420 of collecting a plurality of data samples representative of operating conditions of the communication channel 12 associated to the communication interface 130 of the ECD 100. Each data sample comprises: a measure of the amount of data transmitted by the communication interface 130 over the communication channel 12 during a period of time, a measure of the amount of data received by the communication interface 130 over the communication channel 12 during the period of time, and a connection status of the communication channel 12 during the period of time. Each data sample may include one or more additional type of data representative of the operating conditions of the communication channel 12. Step 420 is performed by the control module 114 executed by the processing unit 110.

The method 400 comprises the step 425 of executing the neural network inference engine 112 by the processing unit 110. The neural network inference engine 112 uses the predictive model (stored in memory 120 at step 415) for inferring a predicted state of the communication channel 12 based on the plurality of data samples (collected at step 420).

The number of data samples used as inputs of the neural network inference engine 112 may vary (e.g. 2, 3, 5, etc.). The period of time during which each data sample is collected may also vary (e.g. thirty seconds, one minute, five minutes, etc.). The period of time has the same duration for each data sample. Alternatively, the period of time is not the same for each data sample. Furthermore, the data samples are collected over consecutive period of times. Alternatively, the data samples are collected over period of times separated by a time interval.

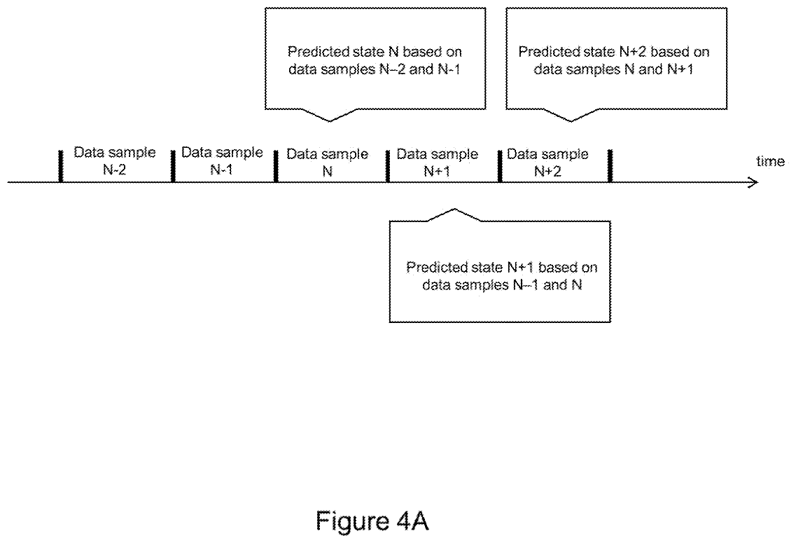

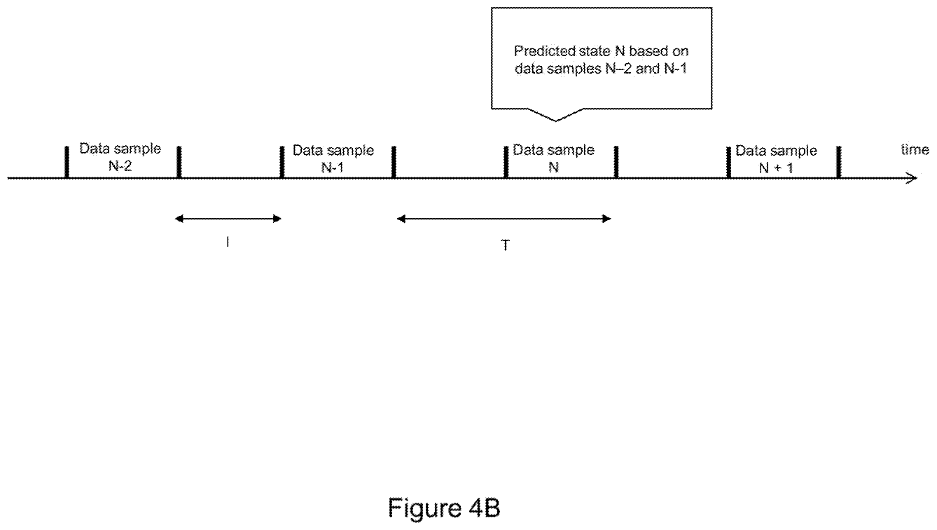

FIG. 4A illustrates a configuration where two data samples having the same duration (e.g. one minute) and being consecutive are used as inputs of the neural network inference engine 112. During the period of time where the data sample N is collected, the predicted state of the communication channel 12 is inferred based on the data samples N−2 and N−1. During the period of time where the data sample N+1 is collected, the predicted state of the communication channel 12 is inferred based on the data samples N−1 and N. During the period of time where the data sample N+2 is collected, the predicted state of the communication channel 12 is inferred based on the data samples N and N+1.

FIG. 4B illustrates a configuration where two data samples having the same duration (e.g. one minute) and being non-consecutive are used as inputs of the neural network inference engine 112. Two subsequent data samples (e.g. N−2 and N−1) are separated by an interval of time I (e.g. one minute). During the period of time T, the predicted state of the communication channel 12 is inferred based on the data samples N−2 and N−1.

The predicted state of the communication channel 12 comprises two states: operational and non-operational. Generally speaking, the operational state means that data can be exchanged over the communication channel 12 with a satisfying level of reliability, while the non-operational state means that data cannot be exchanged over the communication channel 12 with a satisfying level of reliability. For instance, bellow a given error rate (e.g. one IP packet lost per second), the communication channel 12 is considered to be operational; while above the given error rate, the communication channel 12 is considered to be non-operational. The error rate is defined for a bi-directional exchange of data over the communication channel 12. Alternatively, a first error rate is defined for transmission of data by the ECD 100 over the communication channel 12; and a second error rate is defined for reception of data by the ECD 100 over the communication channel 12. Thus, the predicted state of the communication channel 12 being operational means that the predicted error rate of the communication channel 12 is bellow a given threshold (e.g. one IP packet lost per second); and the predicted state of the communication channel 12 being non-operational means that the predicted error rate of the communication channel 12 is above a given threshold. Other measures may be used in place of (or in combination with) the error rate to quantify the operational and non-operation states of the communication channel 12. For example, a retransmission rate (e.g. one IP packet retransmitted per second) can also be used. The error rate, retransmission rate, etc. can be used during a training phase to generate the predictive model, as will be detailed later in the description.

The predicted state of the communication channel 12 may comprise more than two states (e.g. non-operational, degraded and fully-operational) to provide a better granularity for predicting the operation conditions of the communication channel 12.

With respect to the measure of the amount of data transmitted by the communication interface 130 over the communication channel 12 during the period of time (collected by the control module 114 for each data sample), it may consist of several metrics. For example, the measure consists of the number of bytes transmitted by the communication interface 130 over the communication channel 12 during the period of time, the number of Internet Protocol (IP) packets transmitted by the communication interface 130 over the communication channel 12 during the period of time, etc.

With respect to the measure of the amount of data received by the communication interface 130 over the communication channel 12 during the period of time (collected by the control module 114 for each data sample), it may also consist of several metrics. For example, the measure consists of the number of bytes received by the communication interface 130 over the communication channel 12 during the period of time, the number of Internet Protocol (IP) packets received by the communication interface 130 over the communication channel 12 during the period of time, etc.

With respect to the connection status of the communication channel 12 during the period of time, it may also consist of several metrics. For example, the connection status consists of a Boolean indicating whether the communication channel 12 is connected or disconnected during the period of time, the number of times the communication channel 12 has been disconnected during the period of time, etc. In the case of the Boolean, if the communication channel 12 has not been disconnected during the period of time, the Boolean is set to false. If the communication channel 12 has been disconnected at least once during the period of time, the Boolean is set to true.

In the case of a wired (e.g. Ethernet) interface 130, being connected means that a cable is plugged into the wired interface 130; and being disconnected means that a cable is not plugged into the wired interface 130 In the case of a wireless technology, the status of being connected or disconnected may vary from one wireless technology to another. For example, for a communication interface 130 compliant with one of the 802.11 standards, being connected means that the communication interface 130 is associated with a 802.11 (Wi-Fi) access point; and being disconnected means that the communication interface 130 is not associated with a 802.11 (Wi-Fi) access point.

The communication interface 130 (solely or in combination with the processing unit 110) executes monitoring software(s) capable of measuring/determining the data used in the data samples (measure of the amount of data transmitted and received, and connection status). These monitoring software(s) are well known in the art of communication technologies and protocols and will therefore not be detailed in the present disclosure.

Steps 420 and 425 of the method 400 are repeated to constantly evaluate the state of the communication channel 12.

In the case where the predicted state inferred at step 425 is representative of non-satisfying operating conditions of the communication channel 12 (e.g. non-operational as mentioned previously), further actions may be taken by the control module 114 executed by the processing unit 110 of the ECD 100. For example, a testing software is launched to further evaluate the operational state of the communication channel 12. The testing software generally relies on active probing (injection of test traffic to evaluate the operational state of the communication channel 12). Alternatively or complementarily, a warning or error message is displayed on a display of the ECD 100, to inform a user of the ECD 100 that the communication channel 12 is not operational. The warning or error message can also be logged in the memory 120 of the ECD 100, and/or transmitted to another computing device.

During the training phase, the neural network training engine 312 is trained with a plurality of inputs and a corresponding plurality of outputs.

Each input consists of a set of data samples and the corresponding output consists of the state of the communication channel 12. The same number of data samples is used as inputs of the neural network training engine 312 during the training phase and as inputs of the neural network inference engine 312 during the operational phase. As is well known in the art of neural networks, during the training phase, the neural network implemented by the neural network training engine 312 adjusts its weights. Furthermore, during the training phase, the number of layers of the neural network and the number of nodes per layer can be adjusted to improve the accuracy of the model. At the end of the training phase, the predictive model generated by the neural network training engine 312 includes the number of layers, the number of nodes per layer, and the weights.

The inputs and outputs for the training phase of the neural network can be collected through an experimental process. For example, a test ECD 100 is placed in various operating conditions and a plurality of tuples of data samples/corresponding state of the communication channel 12 are collected. The parameters of the data samples are varied dynamically by a user controlling the ECD 100. A first exemplary input comprises the 2 following data samples: [amount of data transmitted=500 packets, amount of data received=300 packets, nb_of_deconnections=1] in the time interval [T, T+1] and [amount of data transmitted=100 packets, amount of data received=60 packets, nb_of_deconnections=3] in the time interval [T+1, T+2]. The corresponding output is: communication channel non-operational in the time interval [T+2, T+3]. A second exemplary input comprises the 2 following data samples: [amount of data transmitted=500 packets, amount of data received=300 packets, nb_of_deconnections=1] in the time interval [T, T+1] and [amount of data transmitted=600 packets, amount of data received=350 packets, nb_of_deconnections=0] in the time interval [T+1, T+2]. The corresponding output is: communication channel operational in the time interval [T+2, T+3]. As mentioned previously, the state of the communication channel 12 can be evaluated by measuring parameter(s) such as error rate(s), retransmission rate(s), etc.; and comparing the measured parameter(s) to pre-defined threshold(s) to determine whether the state of the communication channel 12 is operational or non-operational.

Alternatively, the inputs and outputs for the training phase of the neural network can be collected through a mechanism for collecting data while the ECD 100 is operating in real conditions. For example, a collecting software is executed by the processing unit 110 of the ECD 100. The collecting software records the data samples over a plurality of time intervals. The collecting software further evaluates the state of the communication channel 12 during the plurality of time intervals. As mentioned previously, the state of the communication channel 12 can be evaluated by measuring parameter(s) such as error rate(s), retransmission rate(s), etc.; and comparing the measured parameter(s) to pre-defined threshold(s) to determine whether the state of the communication channel 12 is operational or non-operational.

Various techniques well known in the art of neural networks are used for performing (and improving) the generation of the predictive model, such as forward and backward propagation, usage of bias in addition to the weights (bias and weights are generally collectively referred to as weights in the neural network terminology), reinforcement learning, etc.

During the operational phase, the neural network inference engine 112 uses the predictive model (e.g. the values of the weights) determined during the training phase to infer an output (predicted state of the communication channel 12) based on inputs (a plurality of data samples), as is well known in the art.

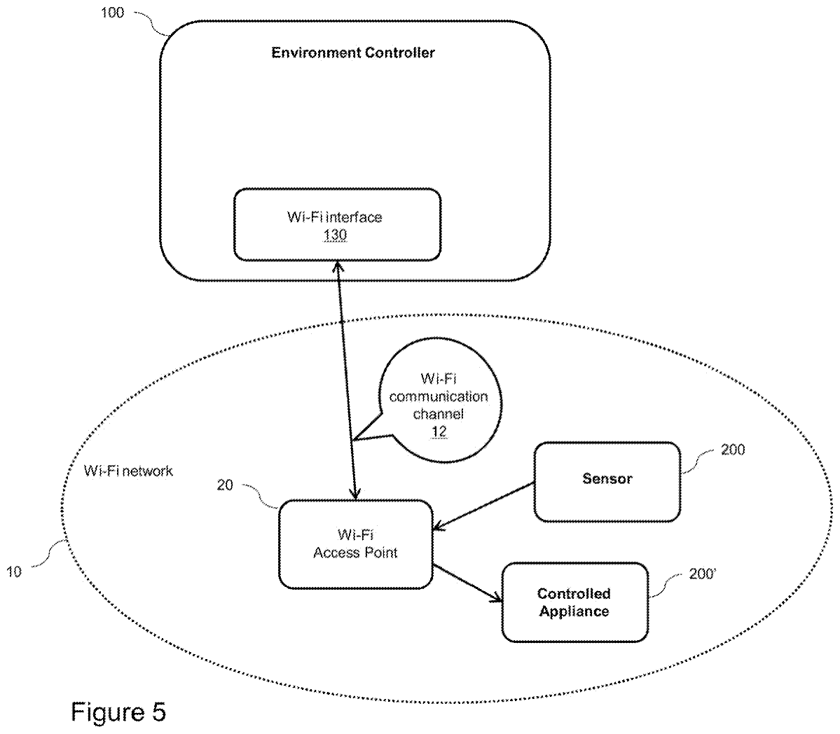

Reference is now made concurrently to FIGS. 2 and 5, where FIG. 5 illustrates an exemplary environment control system where the method 400 is applied. The ECD 100 represented in FIG. 5 corresponds to the ECD 100 represented in FIGS. 1 and 3A.

The environment control system represented in FIG. 5 includes several ECDs: an environment controller 100, a sensor 200, and a controlled appliance 200′. These ECDs interact in a manner well known in the art of environment control systems. For illustration purposes, the environment controller 100 has a Wi-Fi interface 130 to exchange data with the sensor 200 and the controlled appliance 200′ via the Wi-Fi access point 20. The communication channel 12 is a Wi-Fi communication channel.

The sensor 200 detects an environmental characteristic and transmits corresponding environmental data (e.g. an environmental characteristic value) to the environment controller 100 via the Wi-Fi communication channel 12. The environment controller 100 receives the environmental characteristic value from the sensor 200, and determines an environmental state based on the received environmental characteristic value. Then, the environment controller 100 generates a command based on the environmental state; and transmits the command to the controlled appliance 200′ via the Wi-Fi communication channel 12.

Although a single sensor 200 is represented in FIG. 5, a plurality of sensors 200 may transmit environmental data (e.g. environmental characteristic values) to the environment controller 100 via the Wi-Fi communication channel 12. Similarly, although a single controlled appliance 200′ is represented in FIG. 5, the environment controller 100 may transmit commands to a plurality of controlled appliances 200′ via the Wi-Fi communication channel 12.

The method 400 is performed by the environment controller 100 to infer a predicted state of the Wi-Fi communication channel 12 associated to the Wi-Fi interface 130 of the environment controller 100. Similarly, the sensor 200 and the controlled appliance 200′ may perform the method 400 to infer a predicted state of a Wi-Fi communication channel (not represented in FIG. 5 for simplification purposes) between the Wi-Fi access point 20 and a Wi-Fi interface of respectively the sensor 200 and the controlled appliance 200′.

Furthermore, as mentioned previously, the communication channel 12 is not limited to the Wi-Fi standard. Any of an environment controller, sensor and controlled appliance may apply the method 400 for inferring a predicted state of a communication channel associated to a communication interface of respectively the environment controller, sensor and controlled appliance. The communication interface can be wired or wireless, and support various types of standards, such as Wi-Fi, Ethernet, etc.

Additionally, the method 400 is not limited to ECDs, but can be applied to any computing device having a processing unit capable of executing a neural network inference engine and a communication interface having an associated communication channel, as illustrated in FIG. 1.

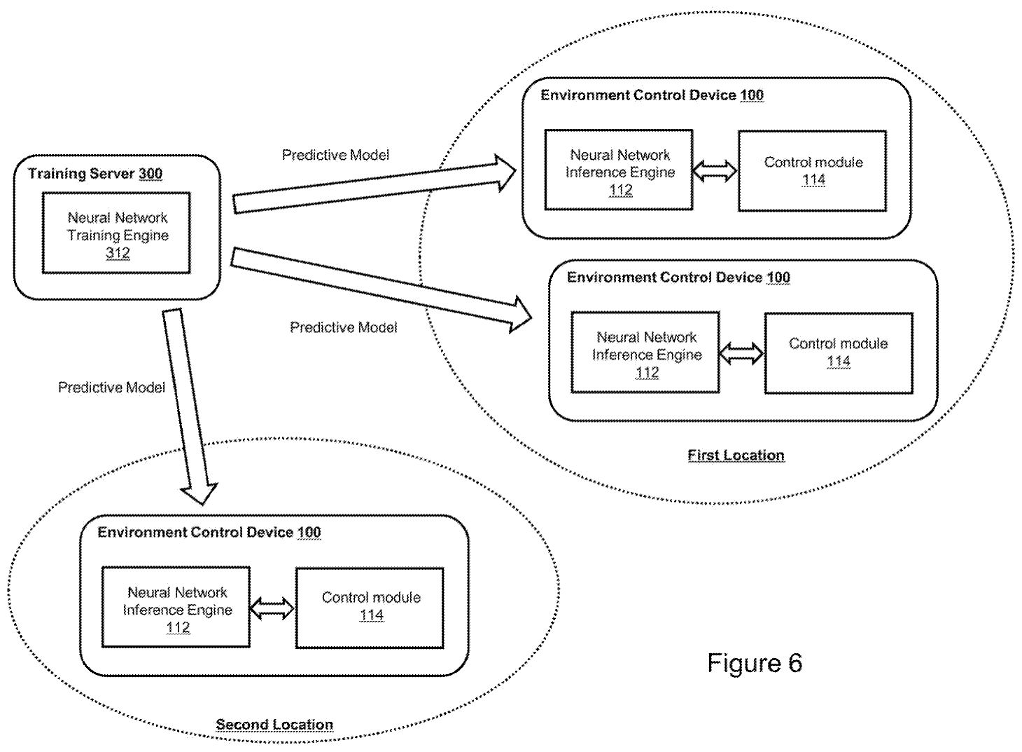

Reference is now made concurrently to FIGS. 1, 2 and 6, where FIG. 6 illustrates the usage of the method 400 in a large environment control system.

A first plurality of ECDs 100 implementing the method 400 are deployed at a first location. Only two ECDs 100 are represented for illustration purposes, but any number of ECDs 100 may be deployed.

A second plurality of ECDs 100 implementing the method 400 are deployed at a second location. Only one ECD 100 is represented for illustration purposes, but any number of ECDs 100 may be deployed.

The first and second locations may consist of different buildings, different floors of the same building, etc. Only two locations are represented for illustration purposes, but any number of locations may be considered.

The ECDs 100 represented in FIG. 6 correspond to the ECDs represented in FIG. 1. The ECDs 100 execute both the control module 114 and the neural network inference engine 112. Each ECD 100 receives a predictive model from the centralized training server 300 (e.g. a cloud based training server 300 in communication with the ECDs 100 via a networking infrastructure, as is well known in the art). The same predictive model is used for all the ECDs. Alternatively, a plurality of predictive models is generated, and takes into account specific operating conditions of the ECDs 100. For example, a first predictive model is generated for the ECDs using a Wi-Fi interface 130, and a second predictive model is generated for the ECDs using an Ethernet interface 130. Furthermore, different predictive models can be generated for different implementations of the same networking technology (e.g. different predictive models corresponding to different 802.11 standards). Additionally, different predictive models can be generated for different types of ECDs 100 (e.g. a predictive model dedicated to environment controllers, another predictive model dedicated to sensors, and still another predictive model dedicated to controlled appliances).

FIG. 6 illustrates a decentralized architecture, where the ECDs 100 autonomously and independently use a neural network to infer a predicted state of a communication channel, using the predictive model as illustrated in the method 400.

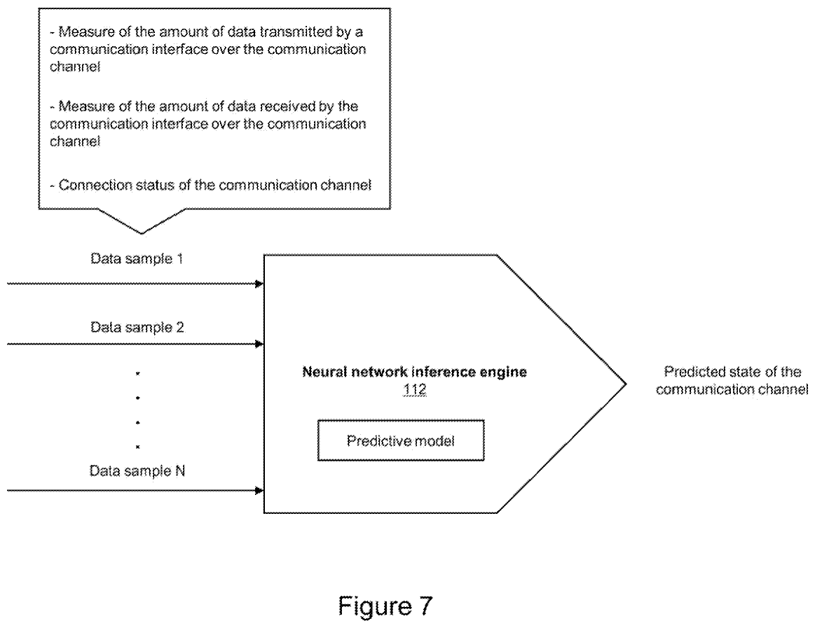

Reference is now made to FIG. 7, which illustrates the aforementioned neural network inference engine with its inputs and its output. FIG. 7 corresponds to the neural network inference engine 112 executed at step 425 of the method 400, as illustrated in FIGS. 1 and 2.

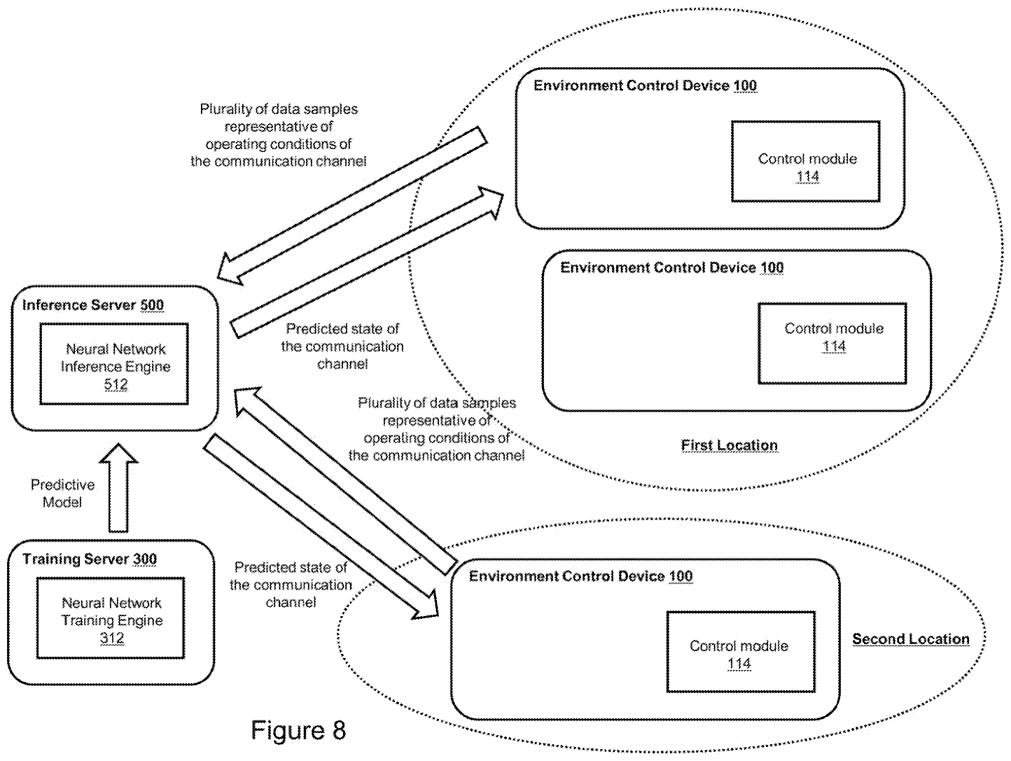

Reference is now made to FIGS. 2, 6 and 8, where FIG. 8 represents an alternative centralized architecture with an inference server 500 executing a neural network inference engine 512.

Instead of having the plurality of ECDs individually executing the corresponding plurality of neural network inference engines 112 (as illustrated in FIG. 6), the neural network inference engine 512 is executed by a processing unit of the dedicated inference server 500 serving the plurality of ECDs 100. Step 425 of the method 400 is performed by the inference server 500.

Each ECD 100 collects the data samples according to step 420 of the method 400; and transmits them to the inference server 500. The inference server performs the inference of the predicted state of the communication channel of the ECD 100 based on the data samples transmitted by the ECD, using the predictive model transmitted by the training server 300. The inference server 500 transmits the predicted state of the communication channel to the ECD 100.

The centralized inference server 500 may be used in the case where some of the ECDs 100 do not have sufficient processing power and/or memory capacity for executing the neural network inference engine 112. The centralized inference server 500 is a powerful server with high processing power and memory capacity capable of executing the neural network inference engine 512 using a complex predictive model (e.g. multiple layers with a large number of neurons for some of the layers). The centralized inference server 500 is further capable of executing several neural network inference engines 512 in parallel for serving a plurality of ECDs in parallel. As mentioned previously, the one or more neural network inference engine 512 executed by the inference server 500 may use the same or different predictive models for all of the ECDs 100 served by the inference server 500.

### Examplary Implementation of the Neural Network

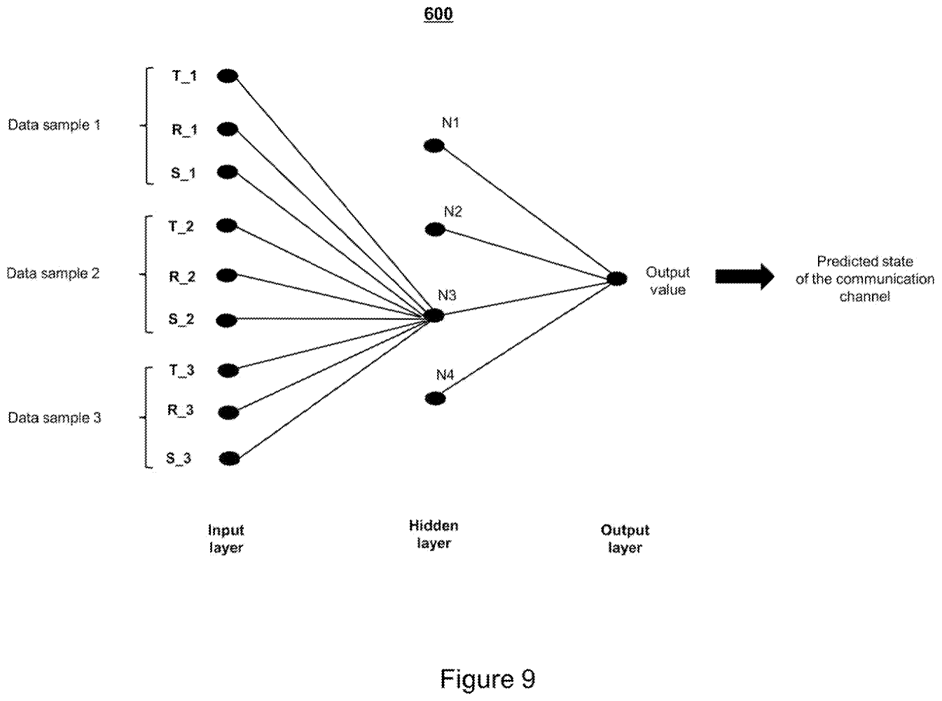

Reference is now made concurrently to FIGS. 1, 7 and 9, where FIG. 9 illustrates an exemplary implementation of a neural network 600 implemented by the neural network inference engine 112 of FIG. 7.

For illustration purposes, the neural network 600 comprises an input layer with 9 neurons for receiving 3 data samples. The number of neurons of the input layer depends on the number of data samples. For instance, if 4 data samples are used, then the input layer comprises 12 neurons for receiving the 4 data samples.

The first data sample represented in FIG. 9 comprises a measure T_1 of the amount of data transmitted by the communication interface 130 over the communication channel 12 during a first period of time, a measure R_1 of the amount of data received by the communication interface 130 over the communication channel 12 during the first period of time, and a connection status S_1 of the communication channel 12 during the first period of time.

The second data sample represented in FIG. 9 comprises a measure T_2 of the amount of data transmitted by the communication interface 130 over the communication channel 12 during a second period of time, a measure R_2 of the amount of data received by the communication interface 130 over the communication channel 12 during the second period of time, and a connection status S_2 of the communication channel 12 during the second period of time.

The third data sample represented in FIG. 9 comprises a measure T_3 of the amount of data transmitted by the communication interface 130 over the communication channel 12 during a third period of time, a measure R_3 of the amount of data received by the communication interface 130 over the communication channel 12 during the third period of time, and a connection status S_3 of the communication channel 12 during the third period of time.

For illustration purposes, the neural network 600 comprises one intermediate hidden layer with 4 neurons N1, N2, N3 and N4. The number of neurons of the hidden layer is determined during the training phase of the neural network 600 and may be different than 4 (e.g. 3, 5 or 6 instead of 4).

Although a single hidden layer is represented in FIG. 9 for simplification purposes, the neural network 600 may comprise more than one hidden layer. The number of consecutive hidden layers and the number of neurons for each hidden layer is determined during the training phase of the neural network 600.

The neural network 600 comprises an output layer with one neuron for outputting an output value, based on which the predicted state of the communication channel 12 is determined.

The one or more hidden layer and the output layer are fully connected. A layer L being fully connected means that each neuron of layer L receives inputs from every neurons of layer L−1, and that each neuron of layer L applies respective weights to the received inputs. By default, the output layer is fully connected to the last hidden layer.

As illustrated in FIG. 9, the neuron of the output layer is connected to the 4 neurons N1, N2, N3 and N4 of the hidden layer. Each neuron of the hidden layer is connected to all the neurons of the input layer. For simplification purposes, only the connections of neuron N3 with all the neurons of the input layer are represented in FIG. 9. However, the neurons N1, N2 and N4 also respectively have connections with all the neurons of the input layer.

Each neuron of a fully connected layer has a weight associated to each one of its connections with the previous layer. These weights correspond to the aforementioned weights of the predictive model, which are calculated during the training phase, and used during the operational phase.

The calculation of the output value of the neural network 600 based on the inputs (the data samples) using the weights allocated to the neurons of the neural network 600 is well known in the art for a neural network using only fully connected hidden layer(s).

For illustration purposes, the neuron N3 has 9 weights (w1_1, w1_2, w1_3, w2_1, w2_2, w2_3, w3_1, w3_2 and w3_3) respectfully associated to the 9 connections with the 9 neurons of the input layer. The output value O3 of neuron N3 is calculated as follows: O3=w1_1*T_1+w1_2*R_1+w1_3*S_1+w2_1*T_2+w2_2*R_2+w2_3*S_2+w3_1*T_3+w3_2*R_3+w3_3*S_3. The same mechanism is applied for calculating the respective output values O1, O2 and O4 of the neurons N1, N2 and N4.

For illustration purposes, the neuron of the output layer has 4 weights (w1, w2, w3 and w4) respectfully associated to the 4 connections with the 4 neurons N1, N2, N3 and N4 of the hidden layer. The output value O of the neuron of the output layer is calculated as follows: O=w1*O1+w2*O2+w3*O3+w4*O4.

In the case where the neural network 600 has more than one hidden layer, the mechanism for calculating the output values of the neurons (N1, N2, N3 and N4) of the first hidden layer based on the inputs of the neurons of the input layer can be easily adapted, for example for calculating the output values of the neurons of a second hidden layer based on the output values of the neurons of the first hidden layer.

The mechanism for the calculation of the output value of a neuron may involve additional steps, as is well known in the art of neural networks. For example, the result of the calculation of the output value of a neuron is corrected by a bias associated to the neuron. In another example, the result of the calculation of the output value of a neuron is corrected by an activation function. Different types of activation functions may be used for the hidden layer(s) and the output layer. Examples of activations functions typically used for the hidden layer(s) include sigmoid functions, hyperbolic tangent functions, Rectified Linear Unit activation functions, etc. Examples of activations functions typically used for the output layer include linear functions, sigmoid functions, softmax functions, etc.

The predicted state of the communication channel 12 is determined by the processing unit 110 based on the output value O of the neuron of the output layer.

We now consider the case where the predicted state of the communication channel 12 takes two discrete values, consisting of operational and non-operational.

In a first exemplary implementation, the activation function of the output layer is a sigmoid function, and the output value O of the neuron of the output layer takes a value between 0 and 1 representing a probability of the communication channel 12 being operational. If the output value O is greater or equal than 0.5 then the communication channel 12 is operational. If the output value O is lower than 0.5 then the communication channel 12 is non-operational.

In a second exemplary implementation, the activation function of the output layer is a linear function, and the output value O of the neuron of the output layer takes a near-one-value (a value substantially equal to 1) or a near-zero-value (a value substantially equal to 0). If the output value O is the near-one-value then the communication channel 12 is operational. If the output value O is the near-zero-value then the communication channel 12 is non-operational.

We now consider the case where the predicted state of the communication channel 12 takes three discrete values, consisting of (fully) operational, degraded and non-operational.

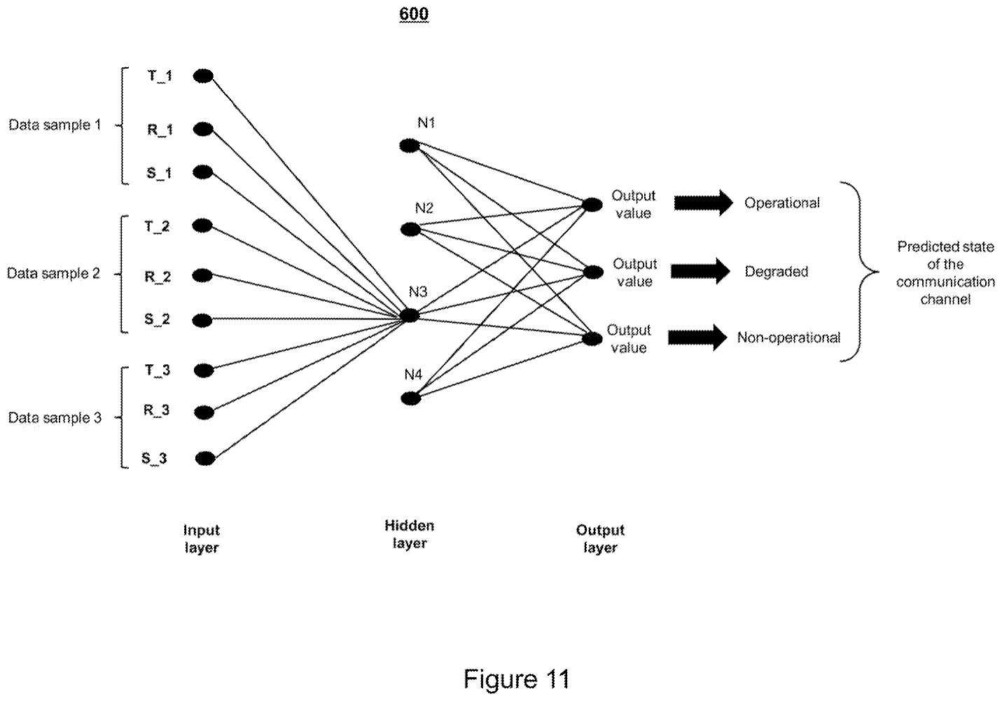

The first exemplary implementation using the sigmoid activation function for the output layer is not adapted to discriminate between more than two discrete values. In this case, the neural network 600 represented in FIG. 11 is mode adapted.

The second exemplary implementation can be adapted to 3 different discrete values. The output value O of the neuron of the output layer takes a near-one-value (a value substantially equal to 1), a near-zero-value (a value substantially equal to 0) or a near-median-value (a value substantially equal to 0.5). If the output value O is the near-one-value then the communication channel 12 is (fully) operational. If the output value O is the near-zero-value then the communication channel 12 is non-operational. If the output value O is the near-median-value then the communication channel 12 is degraded.

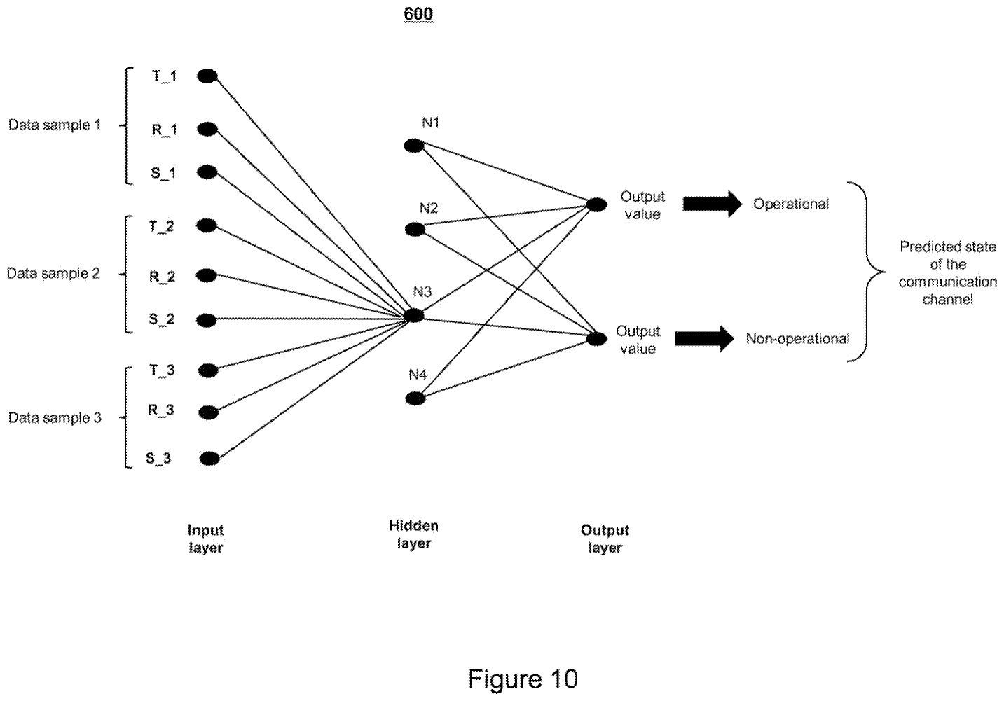

Reference is now made concurrently to FIGS. 1, 7, 10 and 11, where FIGS. 10 and 11 illustrate another exemplary implementation of the neural network 600 implemented by the neural network inference engine 112 of FIG. 7.

The neural network 600 illustrated in FIGS. 10 and 11 is similar to the neural network 600 illustrated in FIG. 9, except for the output layer containing several neurons.

We consider the case where the predicted state of the communication channel 12 takes discrete values. Each discrete value is represented by one neuron of the output layer. FIG. 10 illustrates the case of two discrete values consisting of operational and non-operational; while FIG. 11 illustrates the case of three discrete values consisting of (fully) operational, degraded and non-operational.

Each neuron of the output layer is fully connected to all the neurons of the (last) hidden layer. The previously described calculation of the output value of a neuron of the hidden layer(s) and the output value of a neuron of the output layer in relation to the neural network 600 represented in FIG. 9 is applicable to the neural network 600 represented in FIGS. 10 and 11.

In an exemplary implementation, the activation function of the output layer is a softmax function, the output value O of each neuron of the output layer takes a value between 0 and 1, and the sum of the output values of the neurons of the output layer is equal to 1 (each output value represents a predicted probability). The state of the communication channel 12 is determined by the neuron of the output layer having the highest output value.

For example, referring to FIG. 10, if the output value of the first neuron of the output layer is 0.2 and the output value of the second neuron of the output layer is 0.8 then the state of the communication channel 12 is non-operational.

For example, referring to FIG. 11, if the output value of the first neuron of the output layer is 0.2, the output value of the second neuron of the output layer is 0.7 and the output value of the third neuron of the output layer is 0.1 then the state of the communication channel 12 is degraded.

The design of the neural network 600 can be adapted to a communication channel 12 having a state consisting of N discrete values, N being any integer greater than 1. The neural network 600 has an output layer with N neurons respectively representative of one of the states of the communication channel.

As mentioned previously, the values of the weights of the neural network 600 are calculated during a training phase, for example by applying a backward propagation algorithm to training data sets, each training data set comprising a set of data samples and corresponding expected output value(s) of the output layer of the neural network 600 representing a corresponding expected state of the communication channel 12. The choice of the activation functions (or absence of activation function for a given layer) is also performed during the training phase. An experimental process for implementing the training phase (in particular for collecting training data sets) has been described previously.

Listening Only State without Receiving Data

Reference is now made concurrently to FIGS. 1, 2 and 7. As mentioned previously, the communication channel 12 requires high availability and resistance to transmission errors. However, when using certain protocols such as the Internet Protocol (IP), nothing is actually occurring on the communication channel 12 unless an actual communication over the communication channel 12 is taking place. This makes it hard to detect if the communication channel 12 is not in an operational state when nothing is transmitted over the communication channel 12 for a certain amount of time. For example, if the environment control device 100 is in a listening only state on the communication interface 130, it is hard to tell whether the fact of receiving no data through the communication channel 12 is normal or if the communication channel 12 is not in an operational state.

A modification to the implementation of the method 400 consists in performing step 425 (the execution of the neural network inference engine 112) only when a determination is made by the processing unit 110 that the environment control device 100 has been in a listening only state on the communication interface 130 for a given amount of time without receiving any data through the communication channel 112.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A computing device, comprising:
a communication interface, the communication interface allowing an exchange of data between the computing device and at least one remote computing device over a communication channel associated to the communication interface;
memory for storing a predictive model generated by a neural network training engine, the predictive model comprising weights of a neural network; and
a processing unit comprising one or more processor for:
collecting a plurality of data samples representative of operating conditions of the communication channel, each data sample comprising: a measure of the amount of data transmitted by the communication interface over the communication channel during a period of time, a measure of the amount of data received by the communication interface over the communication channel during the period of time, and a connection status of the communication channel during the period of time;
executing a neural network inference engine, the neural network inference engine implementing the neural network, the neural network comprising an input layer followed by at least one hidden layer followed by an output layer, the input layer comprising neurons receiving the plurality of data samples, the output layer comprising one or more neuron respectively outputting an output value, the neural network using the weights for calculating the one or more output value based on the plurality of data samples; and
determining a predicted state of the communication channel based on the one or more output value calculated by the neural network, the predicted state of the communication channel taking one value among a set of discrete values, the set of discrete values comprising operational and non-operational.

2. The computing device of claim 1, wherein the period of time has the same duration for each one of the data samples.

3. The computing device of claim 1, wherein the data samples are collected over consecutive periods of time.

4. The computing device of claim 1, wherein the communication interface is a wired communication interface, and the communication channel consists of a cable connected to the communication interface.

5. The computing device of claim 1, wherein the communication interface is a wireless communication interface, and the communication channel consists of one or more radio channel provided by the communication interface.

6. The computing device of claim 1, wherein the measure of the amount of data transmitted by the communication interface over the communication channel during the period of time consists of: the number of bytes transmitted by the communication interface over the communication channel during the period of time, or the number of Internet Protocol (IP) packets transmitted by the communication interface over the communication channel during the period of time.

7. The computing device of claim 1, wherein the measure of the amount of data received by the communication interface over the communication channel during the period of time consists of: the number of bytes received by the communication interface over the communication channel during the period of time, or the number of IP packets received by the communication interface over the communication channel during the period of time.

8. The computing device of claim 1, wherein the connection status of the communication channel during the period of time consists of: a Boolean indicating whether the communication channel is connected or disconnected during the period of time, or the number of times the communication channel has been disconnected during the period of time.

9. The computing device of claim 1, wherein the computing device consists of an environment control device (ECD).

10. The computing device of claim 9, wherein the ECD consists of: an environment controller, a sensor, or a controlled appliance.

11. The computing device of claim 1, wherein the execution of the neural network inference engine is performed when a determination is made by the processing unit that the computing device has been in a listening only state on the communication interface for a given amount of time without receiving any data through the communication channel.

12. A method using a neural network to infer a predicted state of a communication channel, the method comprising:
storing a predictive model generated by a neural network training engine in a memory of a computing device, the predictive model comprising weights of a neural network;
collecting by a processing unit of the computing device a plurality of data samples representative of operating conditions of the communication channel, the communication channel being associated to a communication interface of the computing device, the communication interface allowing an exchange of data between the computing device and at least one remote computing device over the communication channel, each data sample comprising: a measure of the amount of data transmitted by the communication interface over the communication channel during a period of time, a measure of the amount of data received by the communication interface over the communication channel during the period of time, and a connection status of the communication channel during the period of time;
executing by the processing unit of the computing device a neural network inference engine, the neural network inference engine implementing the neural network, the neural network comprising an input layer followed by at least one hidden layer followed by an output layer, the input layer comprising neurons receiving the plurality of data samples, the output layer comprising one or more neuron respectively outputting an output value, the neural network using the weights for calculating the one or more output value based on the plurality of data samples; and
determining by the processing unit of the computing device a predicted state of the communication channel based on the one or more output value calculated by the neural network, the predicted state of the communication channel taking one value among a set of discrete values, the set of discrete values comprising operational and non-operational.

13. The method of claim 12, wherein the period of time has the same duration for each one of the data samples.

14. The method of claim 12, wherein the data samples are collected over consecutive periods of time.

15. The method of claim 12, wherein the communication interface is a wired communication interface and the communication channel consists of a cable connected to the communication interface; or the communication interface is a wireless communication interface and the communication channel consists of one or more radio channel provided by the communication interface.

16. The method of claim 12, wherein the measure of the amount of data transmitted by the communication interface over the communication channel during the period of time consists of: the number of bytes transmitted by the communication interface over the communication channel during the period of time, or the number of Internet Protocol (IP) packets transmitted by the communication interface over the communication channel during the period of time.

17. The method of claim 12, wherein the measure of the amount of data received by the communication interface over the communication channel during the period of time consists of: the number of bytes received by the communication interface over the communication channel during the period of time, or the number of IP packets received by the communication interface over the communication channel during the period of time.

18. The method of claim 12, wherein the connection status of the communication channel during the period of time consists of: a Boolean indicating whether the communication channel is connected or disconnected during the period of time, or the number of times the communication channel has been disconnected during the period of time.

19. The method of claim 12, wherein the execution of the neural network inference engine is performed when a determination is made by the processing unit that the computing device has been in a listening only state on the communication interface for a given amount of time without receiving any data through the communication channel.

20. A non-transitory computer program product comprising instructions executable by a processing unit of a computing device, the execution of the instructions by the processing unit of the computing device providing for using a neural network to infer a predicted state of a communication channel by:
storing a predictive model generated by a neural network training engine in a memory of the computing device, the predictive model comprising weights of a neural network;
collecting by the processing unit of the computing device a plurality of data samples representative of operating conditions of the communication channel, the communication channel being associated to a communication interface of the computing device, the communication interface allowing an exchange of data between the computing device and at least one remote computing device over the communication channel, each data sample comprising: a measure of the amount of data transmitted by the communication interface over the communication channel during a period of time, a measure of the amount of data received by the communication interface over the communication channel during the period of time, and a connection status of the communication channel during the period of time;
executing by the processing unit of the computing device a neural network inference engine, the neural network inference engine implementing the neural network, the neural network comprising an input layer followed by at least one hidden layer followed by an output layer, the input layer comprising neurons receiving the plurality of data samples, the output layer comprising one or more neuron respectively outputting an output value, the neural network using the weights for calculating the one or more output value based on the plurality of data samples; and
determining by the processing unit of the computing device a predicted state of the communication channel based on the one or more output value calculated by the neural network, the predicted state of the communication channel taking one value among a set of discrete values, the set of discrete values comprising operational and non-operational.
